(19) United States
(12) Patent Application Publication
(10) Pub. No.: US 2018/0202218 A1
(43) Pub. Date: Jul. 19, 2018

(54) Garage Door Trolley Shield

(71) Applicant: Rolando Guerra, Weslaco, TX (US)

(72) Inventor: Rolando Guerra, Weslaco, TX (US)

(73) Assignee: Matulewicz & Associates, P.C., McAllen, TX (US)

(21) Appl. No.: 15/530,456

(22) Filed: Jan. 17, 2017

(51) Int. Cl. E06B 5/11; E05B 13/00; E05C 21/00

(52) U.S. Cl. CPC E06B 5/11; E05C 21/00; E05B 13/001

(57) ABSTRACT

A device used to shield the garage door trolley and lever in order to protect the mechanism from being actuated by outside intruders. The invention is designed to be assembled to the garage door trolley, leaving free access to the lever from the inside of the garage. The design is a solid two-piece shield that attaches tightly to the garage door trolley, letting the trolley and lever move freely as intended, but protecting the lever from being pulled open from the outside of the garage door.

### I. FIELD

The present subject matter relates to garage doors. More specifically, it relates to the usage and operation of a garage door trolley. Garage door trolleys are secured, shielded, or tied in order to stop intruders from opening the door from outside the garage.

### II. BACKGROUND

Garage break-ins have been increasing since the release of several videos showing step-by-step instructions of how to break into a garage by pulling the manual release lever of the garage trolley with a hook wire. This can be easily done within seconds from the outside, and is very simple to do. This has led to an increase of break-ins, while very little has been done to secure the manual levers. Very few if any devices have been invented to keep the lever secured from burgles. Some people have resorted to using plastic zip ties or wires to lock the lever, but these “homemade solutions” must be removed before the release ring can be pulled from the inside. These options are unsafe in the event of an emergency. The present invention seeks to provide a safe shield that will enable the user to pull the lever unrestrictedly from the inside while protecting the lever from being pulled from the outside.

### III. SUMMARY

The present invention comprises an innovative two-piece shield that provides an effective protection of the lever from being pulled in a horizontal direction, thus keeping the lever from being actuated by someone outside the door. When the trolley lever is pulled from outside, burgles use a wire that enters through the top of the garage door, pulling parallel to the garage door rail. This horizontal motion locks the ring inside the garage door trolley shield. The ring is attached closely to the lever, hanging inside the shield. The ring works as a not, sopping the lever from opening when pulled in this direction. The only pulling angle permitted by the trolley shield is a perpendicular angle. This vertical motion is allowed by the trolley shield. The shield has an opening in the bottom for the ring to go through and thus allowing the lever to move freely. The only way to pen a garage door with the trolley shield, is by pulling in a vertical direction. This can only be done from inside the garage.

### IV. BRIEF DESCRIPTION OF DRAWINGS

FIG. 1 is a perspective view of the two garage door trolley shield pieces, and the garage trolley attached to the garage rail.

FIG. 2 is a perspective view of the two garage door trolley shield pieces together after snapping on, shielding the garage door trolley attached to the rail.

FIG. 3 is a side elevation view of the garage door trolley shield attached to the garage trolley.

FIG. 4 is a perspective view of the simple two-piece assembly, showing the configuration of each piece coming together to shield the garage door trolley.

FIG. 5 is a section view of the trolley shield right side piece, attached to the garage trolley, and the lever at its original position.

FIG. 6 is a section view of the trolley shield right side piece, attached to the garage trolley. The cord is pulled horizontally, while the shield stops the ring from moving and stopping the lever from being pulled open.

FIG. 7 is a section view of the trolley shield right side piece, attached to the garage trolley. The cord is pulled down vertically, and the lever moves freely as intended to open the garage door. The bottom opening of the shield allows the ring to go through.

### V. DETAILED DESCRIPTION OF DRAWINGS

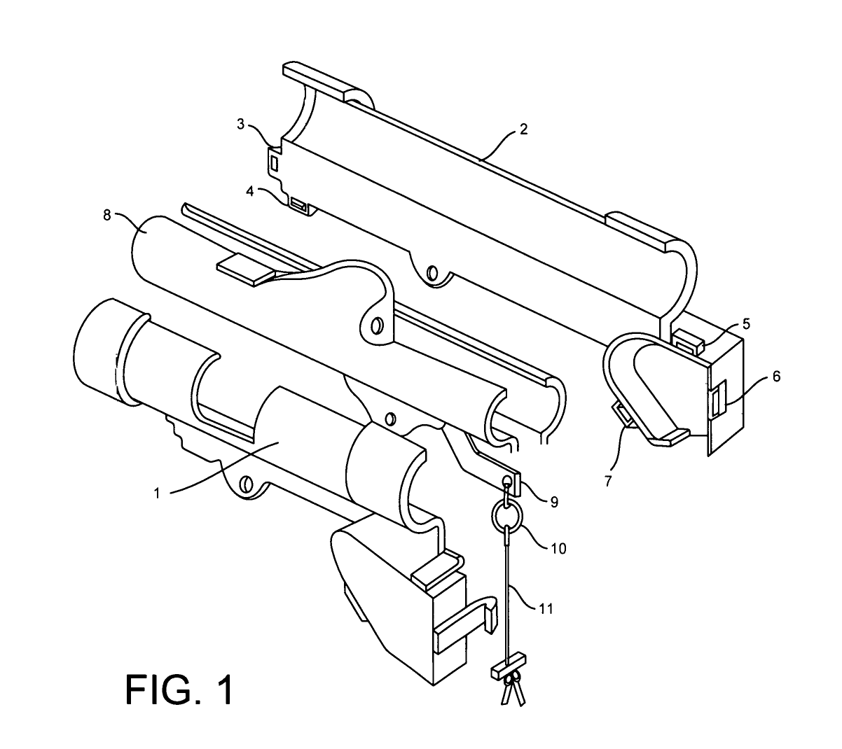

FIG. 1 shows the two garage door trolley shield pieces and points out the five snap fit sockets where the snap fits go through in order to snap on both pieces together. The garage door trolley is also represented, attached to the garage door rail.

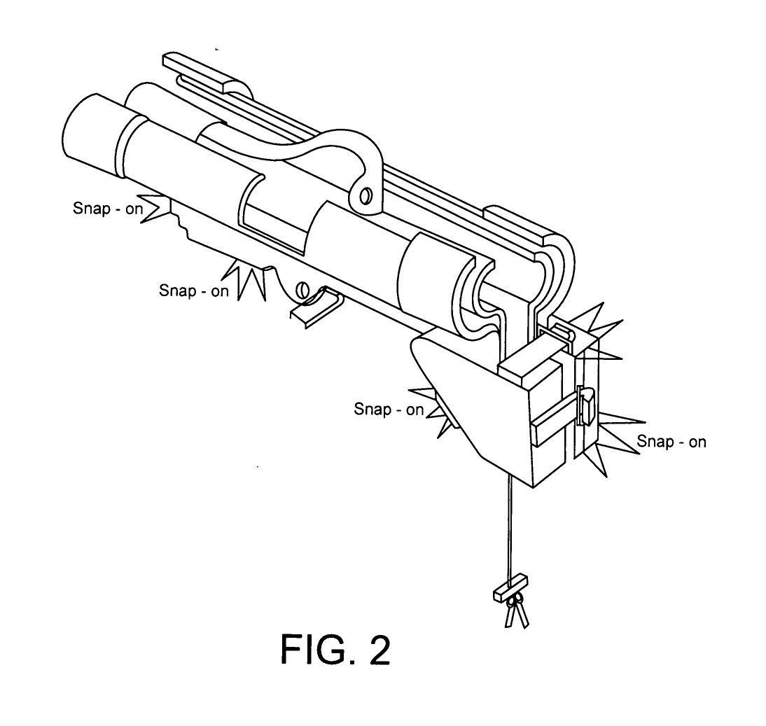

FIG. 2 shows the assembled garage door trolley shield after attaching both pieces together using the snap fits. The figure shows the attached shield using snap fits that assemble the two pieces tightly together to the trolley, allowing no room for the shield do swing around.

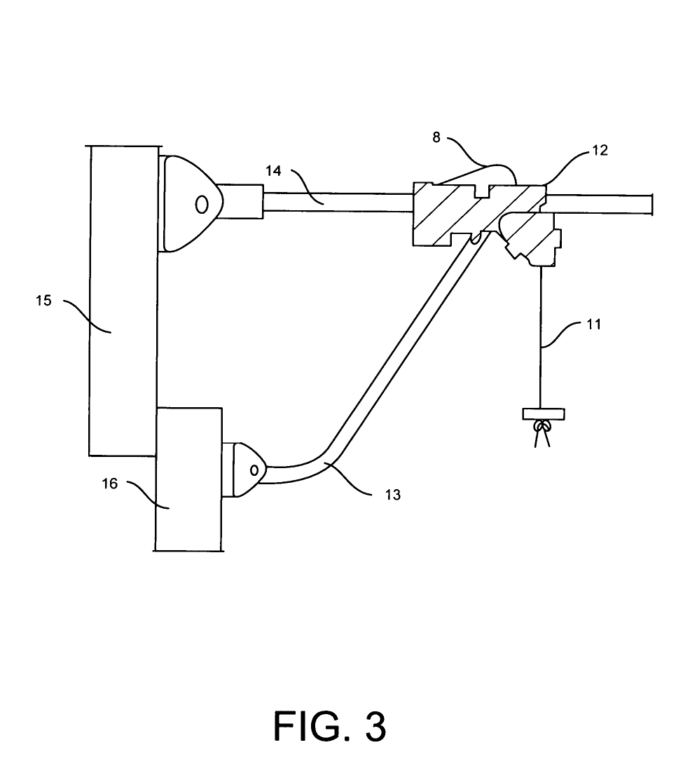

FIG. 3 shows the side view of the assembled invention, as a possible representation of how it will look when attached to the garage door trolley. It shows the different components of the garage door that surround the garage door trolley shield.

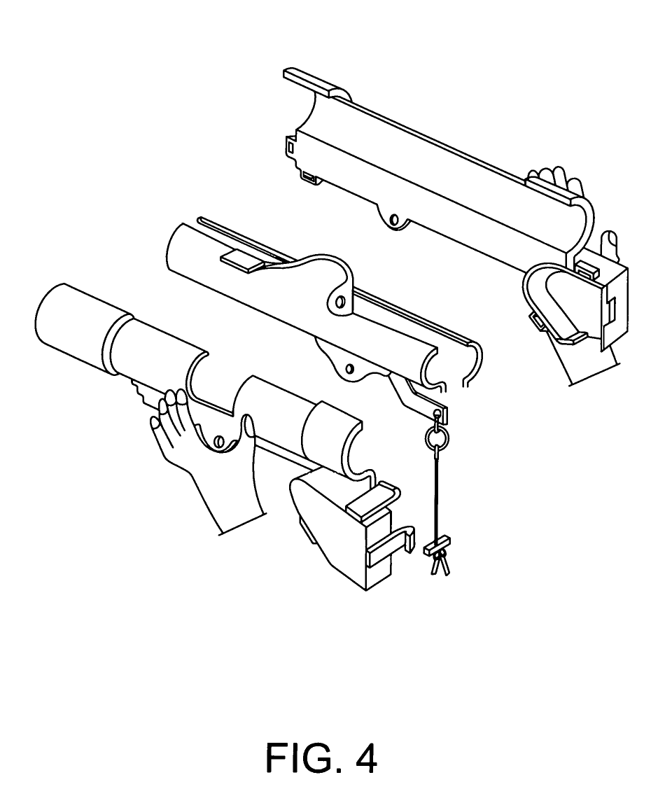

FIG. 4 shows a perspective view of the easy assembly method using both hands to snap on together the two garage door trolley shield pieces. The assembly does not require tools, and it comes ready to be assembled on the trolley in a very simple way.

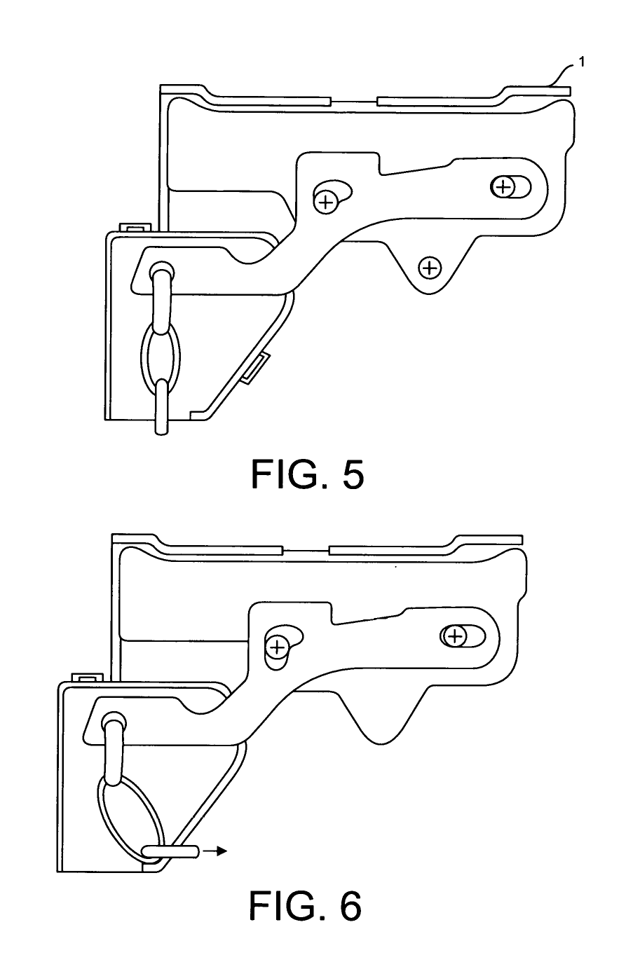

FIG. 5 shows the inside mechanism of the garage door trolley and the lever, with the shield attached to the trolley. The lever is at its original position. A cord attaches the ring to the lever, and another cord hangs down in order to be accessible for the user.

FIG. 6 shows the inside mechanism of the garage door trolley and the lever, with the shield attached to the trolley. The hanging cord is pulled horizontally, thus locking the ring inside the garage door trolley shield. The shield does not let the ring move, stopping the garage door from opening.

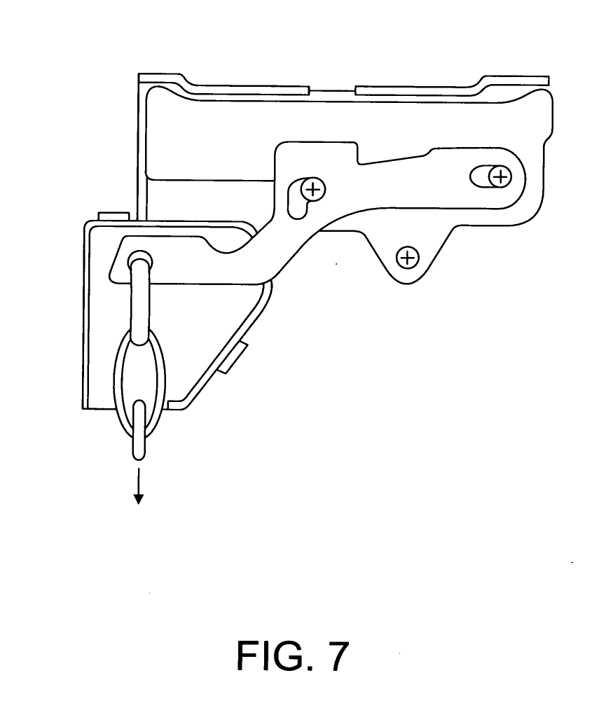

FIG. 7 shows the inside mechanism of the garage door trolley and the lever, with the shield attached to the trolley. The hanging cord is pulled down vertically, and the lever moving freely in order to open the garage door. The lever is able to move as intended, and the ring is not locked inside the shield. The shield has an opening at the bottom which is of the right size in order to allow the ring to go through. The opening allows the cord to be pulled only in this direction.

### VI. DETAILED DESCRIPTION OF THE PRODUCT AND METHOD

The Garage Opener Trolley Shield is intended to be a safe, affordable, simple, and lasting solution to the problem of outside intruders having access to the garage door trolley lever. The shield protects the garage door mechanism from the outside yet allows for easy, manual release from the inside.

FIG. 3 shows a perspective view of the invention in an assembled state. The Trolley shield consists of two components, which are symmetric pieces that assemble around the trolley, shielding the trolley and the lever. The two pieces have the shape of the trolley mechanism, tightening close to the trolley, and thus making it a non-bulky and aesthetically pleasing component. In order to assemble the shield, one must place a piece of the shield on one side of the trolley, then place the second piece on the other side of the trolley respectively, and press until the snaps are actuated. It is configured to be attached to the trolley and be left there permanently. In case it must be removed, the shield is easy to disassemble and detach. This can be done by pressing up on the snap fits to release the two pieces.

FIG. 4 shows a perspective view of the interior of the assembled shield, along with the lever in its original and pulled position. It shows the lever moving freely inside the assembled shield. The design of the shield is such that it leaves a slight opening along the bottom of the shield in order for the lever to move down as intended. The shield leaves an orifice on both sides of the original orifice of the trolley.

The shield also leaves a wide opening on the bottom where the ring attachment is, in order to leave room for it to be accessed and pulled down vertically as intended.

FIG. 1 shows a perspective view of the whole lever piece in two positions. Additionally, it shows the ring attached in three different positions. Position one of the lever shows the normal resting lever, and the second position shows the lever being pulled down. The three positions of the ring include the resting position, lever lock position, and access lever position. The first position shows the ring resting. The second position shows the ring being pulled horizontally (parallel to the garage rail). These positions show the lever being locked, restricting the ring from being pulled down to open the garage door. The third position shows the ring pulled down vertically. This position shows the free access to the lever when It Is pulled down.

### VII. BENEFITS

Practical to assemble and disassemble.

Keeps the lever protected without altering the intended motion of the trolley and lever mechanism.

A safe component, leaving full access to the lever from inside in case of an emergency.

The lasting material, making it a permanent shield that will not have to be replaced.

Tough and tight clasped shield, making it safe and reliable.

Non-bulky and aesthetically pleasing shield.

I claim:

1. A garage trolley shield configured to be attached to the trolley, comprising of:
a) A left side piece to be attached to the trolley, and assembled with the right side piece;
b) A right side piece to be assembled with the left piece;
c) A ring.

2. The garage trolley shield of claim 1 with two orifices matching the original trolley orifice.

3. The garage trolley shield of claim 2 comprising five snap fits used to attach the shield to the trolley.

4. The garage trolley shield of claim 3 with a wide opening on the bottom for easy access to the ring attached to the trolley lever.

5. The garage trolley shield of claim 4 with a slight opening at the bottom of the shield for the trolley lever to move freely.
